(19) United States
(12) Patent Application Publication
(10) Pub. No.: US 2008/0281049 A1
(43) Pub. Date: Nov. 13, 2008

(54) Process for Preparing Water-Absorbing Polymers with High Absorption Capacity and High Permeability

(75) Inventors: Martin Wendker, Worms (DE); Norbert Herfert, Altenstadt (DE); Paul Walter McCormack, Neustadt (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: BASF SE, Ludwigshafen (DE)

(21) Appl. No.: 12/093,097

(22) PCT Filed: Nov. 30, 2006
(86) PCT No.: PCT/EP2006/069088

§ 371 Date: May 8, 2008

Related U.S. Application Data
(60) Provisional application No. 60/742,458, filed on Dec. 5, 2005.

(51) Int. Cl. C08F 265/02; C08F 20/06

(52) U.S. Cl. 525/278; 525/303

(57) ABSTRACT

A process for preparing water-absorbing polymers by polymerizing a monomer solution comprising
at least one ethylenically unsaturated, acid-bearing monomer which may be at least partly neutralized,
from 0.01 to 0.5% by weight of at least one crosslinker based on the monomer,
   by polymerizing the monomer solution and aftertreating the resulting polymer with
from 0.05 to 0.25% by weight of at least one postcrosslinker, based on the polymer, where the crosslinker is not a polyol, and
from 0.05 to 0.5% by weight of at least one polyvalent cation based on the polymer.

The present invention relates to processes for preparing water-absorbing polymers with high absorption capacity and high permeability, to the water-absorbing polymers and to hygiene articles which comprise them.

Water-absorbing polymers are especially polymers of (co)polymerized hydrophilic monomers, graft (co)polymers of one or more hydrophilic monomers on a suitable graft base, crosslinked cellulose ethers or starch ethers, crosslinked carboxymethylcellulose, partly crosslinked polyalkylene oxide or natural products swellable in aqueous liquids, for example guar derivatives. Such polymers, as products which absorb aqueous solutions, are used to produce diapers, tampons, sanitary napkins and other hygiene articles, but also as water-retaining agents in market gardening.

The preparation of water-absorbing polymers has been described many times; see, for example, “Modern Superabsorbent Polymer Technology”, F. L. Buchholz and A. T. Graham, Wiley-VCH, 1998, pages 69 to 117.

Water-absorbing polymers typically have a Centrifuge Retention Capacity of from 25 to 60 g/g, preferably of at least 30 g/g, preferentially of at least 32 g/g, more preferably of at least 34 g/g, most preferably of at least 35 g/g. The Centrifuge Retention Capacity (CRC) is determined according to the EDANA (European Disposables and Nonwovens Association) test method No. 441.2-02 “Centrifuge Retention Capacity”.

To improve the performance properties, for example permeability, water-absorbing polymers are generally postcrosslinked. This postcrosslinking can be carried out in aqueous gel phase. However, preference is given to coating ground and sieved polymer particles (base polymer) with a postcrosslinker on the surface, drying and thermally postcrosslinking them. Crosslinkers suitable for this purpose are compounds which comprise at least two groups which can form covalent bonds with the carboxylate groups of the hydrophilic polymer or which can crosslink at least two carboxyl groups or other functional groups of at least two different polymer chains of the base polymer with one another.

The postcrosslinking lowers the absorption capacity of the water-absorbing polymers, i.e. absorption capacity and permeability are diametric properties.

EP-A 372 981 discloses water-absorbing polymers with improved absorption and durability in the wet state.

EP-A 574 260 describes a process for preparing water-absorbing polymers with a low level of residual monomers.

U.S. Pat. No. 5,684,106 teaches the preparation of water-absorbing polymers with improved property profile.

WO 00/22018 discloses water-absorbing polymers with high absorption capacity and improved capillarity.

WO 00/53644, WO 00/53664, WO 02/20068 and WO 02/22717 describe water-absorbing polymers with improved properties, especially retention, retention capacity and transport of liquids.

It was an object of the present invention to provide water-absorbing polymers with high absorption capacity and high permeability.

This object is achieved by a process for preparing water-absorbing polymers by polymerizing a monomer solution comprising
a) at least one ethylenically unsaturated, acid-bearing monomer which may be at least partly neutralized,
b) from 0.01 to 0.5% by weight of at least one crosslinker based on the monomer a),
c) if desired one or more ethylenically and/or allylically unsaturated monomers copolymerizable with the monomers mentioned under a) and
d) if desired one or more water-soluble polymers,
   by polymerizing the monomer solution and aftertreating the resulting polymer with
e) from 0.05 to 0.25% by weight of at least one postcrosslinker, based on the polymer, where the crosslinker is not a polyol, and
f) from 0.05 to 0.5% by weight of at least one polyvalent cation based on the polymer.

The present invention is based on the fact that absorption capacity and permeability behave in a virtually additive manner under certain conditions. Use of relatively small amounts of crosslinker b) and postcrosslinker e) affords water-absorbing polymers with high absorption capacity. The aftertreatment with the polyvalent cation f) leads to an increase in the permeability without the distinct decline in absorption capacity which is otherwise customary.

In principle, polyols are also known as postcrosslinkers. However, the use of polyols as postcrosslinkers leads to an undesirably high decline in the absorption capacity.

The aftertreatment with the postcrosslinker e) and the polyvalent cation f) can be effected in a common process step. It is possible to meter in the post crosslinker e) and the polyvalent cation f) as a common solution. However, separate metering is advantageous.

It is also possible to meter the postcrosslinker e) and the polyvalent cation f) in separate process steps. In this case, it is advantageous to add the polyvalent cation f) in the subsequent process step.

Suitable monomers a) are, for example, ethylenically unsaturated carboxylic acids such as acrylic acid, methacrylic acid, maleic acid, fumaric acid and itaconic acid. Particularly preferred monomers are acrylic acid and methacrylic acid. Very particular preference is given to acrylic acid.

The content of acrylic acid and/or salts thereof in the total amount of monomers a) is preferably at least 50 mol %, more preferably at least 90 mol %, most preferably at least 95 mol %.

The monomers a), especially acrylic acid, comprise preferably up to 0.025% by weight of a hydroquinone monoether. Preferred hydroquinone monoethers are hydroquinone monomethyl ether (MEHQ) and/or tocopherols.

Tocopherol refers to compounds of the following formula

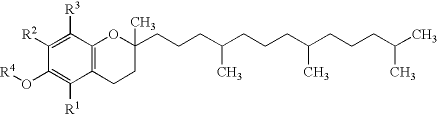

where R¹ is hydrogen or methyl, R² is hydrogen or methyl, R³ is hydrogen or methyl and R⁴ is hydrogen or an acyl radical having from 1 to 20 carbon atoms.

Preferred R⁴ radicals are acetyl, ascorbyl, succinyl, nicotinyl and other physiologically tolerable carboxylic acids. The carboxylic acids may be mono-, di- or tricarboxylic acids.

Preference is given to alpha-tocopherol where R¹=R²═R³=methyl, especially racemic alpha-tocopherol. R¹ is more preferably hydrogen or acetyl. Especially preferred is RRR-alpha-tocopherol.

The monomer solution comprises preferably not more than 130 ppm by weight, more preferably not more than 70 ppm by weight, preferably not less than 10 ppm by weight, more preferably not less than 30 ppm by weight and especially about 50 ppm by weight of hydroquinone monoether, based in each case on acrylic acid, with acrylic acid salts being counted as acrylic acid. For example, the monomer solution can be prepared using acrylic acid having an appropriate hydroquinone monoether content.

The water-absorbing polymers are crosslinked, i.e. the polymerization is carried out in the presence of compounds having at least two polymerizable groups which can be free-radically polymerized into the polymer network. Suitable crosslinkers b) are, for example, ethylene glycol dimethacrylate, diethylene glycol diacrylate, allyl methacrylate, trimethylolpropane triacrylate, triallylamine, tetraallyloxyethane, as described in EP-A 530 438, di- and triacrylates, as described in EP-A 547 847, EP-A 559 476, EP-A 632 068, WO 93/21237, WO 03/104299, WO 03/104300, WO 03/104301 and DE-A 103 31 450, mixed acrylates which, as well as acrylate groups, comprise further ethylenically unsaturated groups, as described in DE-A 103 31 456 and DE-A 103 55 401, or crosslinker mixtures as described, for example, in DE-A 195 43 368, DE-A 196 46 484, WO 90/15830 and WO 02/32962.

Suitable crosslinkers b) include in particular N,N′-methylenebisacrylamide and N,N′-methylenebismethacrylamide, esters of unsaturated mono- or polycarboxylic acids of polyols, such as diacrylate or triacrylate, for example butanediol diacrylate, butanediol dimethacrylate, ethylene glycol diacrylate, ethylene glycol dimethacrylate and also trimethylolpropane triacrylate and allyl compounds, such as allyl (meth)acrylate, triallyl cyanurate, diallyl maleate, polyallyl esters, tetraallyloxyethane, triallylamine, tetraallylethylenediamine, allyl esters of phosphoric acid and also vinylphosphonic acid derivatives as described, for example, in EP-A 343 427. Suitable crosslinkers b) further include pentaerythritol diallyl ether, pentaerythritol triallyl ether, pentaerythritol tetraallyl ether, polyethylene glycol diallyl ether, ethylene glycol diallyl ether, glycerol diallyl ether, glycerol triallyl ether, polyallyl ethers based on sorbitol, and also ethoxylated variants thereof. In the process of the invention, it is possible to use di(meth)acrylates of polyethylene glycols, the polyethylene glycol used having a molecular weight between 300 and 1000.

However, particularly advantageous crosslinkers b) are di- and triacrylates of 3- to 20-tuply ethoxylated glycerol, of 3- to 20-tuply ethoxylated trimethylolpropane, of 3- to 20-tuply ethoxylated trimethylolethane, especially di- and triacrylates of 2- to 6-tuply ethoxylated glycerol or of 2- to 6-tuply ethoxylated trimethylolpropane, of 3-tuply propoxylated glycerol, of 3-tuply propoxylated trimethylolpropane, and also of 3-tuply mixed ethoxylated or propoxylated glycerol, of 3-tuply mixed ethoxylated or propoxylated trimethylolpropane, of 15-tuply ethoxylated glycerol, of 15-tuply ethoxylated trimethylolpropane, of at least 40-tuply ethoxylated glycerol, of at least 40-tuply ethoxylated trimethylolethane and also of at least 40-tuply ethoxylated trimethylolpropane.

Very particularly preferred crosslinkers b) are polyethoxylated and/or -propoxylated glycerols which have been esterified with acrylic acid or methacrylic acid to di- or triacrylates, as described, for example, in DE-A 103 19 462. Di- and/or triacrylates of 3- to 10-tuply ethoxylated glycerol are particularly advantageous. Very particular preference is given to di- or triacrylates of 1- to 5-tuply ethoxylated and/or propoxylated glycerol. The triacrylates of 3- to 5-tuply ethoxylated and/or propoxylated glycerol are most preferred. These are notable for particularly low residual levels (typically below 10 ppm by weight) in the water-absorbing polymer and the aqueous extracts of the water-absorbing polymers produced therewith have an almost unchanged surface tension (typically not less than 0.068 N/m) compared with water at the same temperature.

The amount of crosslinker b) is preferably from 0.05 to 0.4% by weight, more preferably from 0.1 to 0.3% by weight, based in each case on the monomer a).

Examples of ethylenically unsaturated monomers c) which are copolymerizable with the monomers a) are acrylamide, methacrylamide, crotonamide, dimethylaminoethyl methacrylate, dimethylaminoethyl acrylate, dimethylaminopropyl acrylate, diethylaminopropyl acrylate, dimethylaminobutyl acrylate, dimethylaminoethyl methacrylate, diethylaminoethyl methacrylate, dimethylaminoneopentyl acrylate and dimethylaminoneopentyl methacrylate.

Useful water-soluble polymers d) include polyvinyl alcohol, polyvinylpyrrolidone, starch, starch derivatives, polyglycols or polyacrylic acids, preferably polyvinyl alcohol and starch.

The preparation of a suitable polymer and also further suitable hydrophilic ethylenically unsaturated monomers a) are described in DE-A 199 41 423, EP-A 686 650, WO 01/45758 and WO 03/104300.

Suitable reactors are kneading reactors or belt reactors. In the kneader, the polymer gel formed in the polymerization of an aqueous monomer solution is comminuted continuously by, for example, contrarotatory stirrer shafts, as described in WO 01/38402. The polymerization on the belt is described, for example, in DE-A 38 25 366 and U.S. Pat. No. 6,241,928. Polymerization in a belt reactor forms a polymer gel which has to be comminuted in a further process step, for example in a meat grinder, extruder or kneader.

Advantageously, the hydrogel, after leaving the polymerization reactor, is then stored, for example in insulated vessels, at elevated temperature, preferably at least 50° C., more preferably at least 70° C., most preferably at least 80° C., and preferably less than 100° C. The storage, typically for from 2 to 12 hours, further increases the monomer conversion.

The acid groups of the resulting hydrogels have typically been partially neutralized, preferably to an extent of from 25 to 95 mol %, more preferably to an extent of from 50 to 80 mol % and even more preferably to an extent of from 60 to 75 mol %, for which the customary neutralizing agents can be used, preferably alkali metal hydroxides, alkali metal oxides, alkali metal carbonates or alkali metal hydrogencarbonates and also mixtures thereof. Instead of alkali metal salts, it is also possible to use ammonium salts. Particularly preferred alkali metals are sodium and potassium, but very particular preference is given to sodium hydroxide, sodium carbonate or sodium hydrogencarbonate and also mixtures thereof.

Neutralization is preferably carried out at the monomer stage. It is done typically by mixing in the neutralizing agent as an aqueous solution, as a melt, or else preferably as a solid material. For example, sodium hydroxide having a water content of distinctly below 50% by weight can be present as a waxy mass having a melting point of above 23° C. In this case, metering as piece material or melt at elevated temperature is possible.

However, it is also possible to carry out neutralization partly after the polymerization, at the hydrogel stage. It is also possible to neutralize up to 40 mol %, preferably from 10 to 30 mol % and more preferably from 15 to 25 mol % of the acid groups before the polymerization by adding a portion of the neutralizing agent to the monomer solution and setting the desired final degree of neutralization only after the polymerization, at the hydrogel stage. When the hydrogel is neutralized at least partly after the polymerization, the hydrogel is preferably comminuted mechanically, for example by means of a meat grinder, in which case the neutralizing agent can be sprayed, sprinkled or poured on and then carefully mixed in. To this end, the gel mass obtained can be repeatedly ground in the meat grinder for homogenization.

The hydrogel is then preferably dried with a belt dryer until the residual moisture content is preferably below 15% by weight and especially below 10% by weight, the water content being determined by EDANA (European Disposables and Nonwovens Association) recommended test method No. 430.2-02 “Moisture content”. If desired, drying can also be carried out using a fluidized bed dryer or a heated plowshare mixer. To obtain particularly white products, it is advantageous to dry this gel while ensuring rapid removal of the evaporating water. To this end, the dryer temperature must be optimized, the air feed and removal has to be controlled, and sufficient venting must be ensured in each case. The higher the solids content of the gel, the simpler the drying, by its nature, and the whiter the product. The solids content of the gel before the drying is therefore preferably between 30% and 80% by weight. It is particularly advantageous to vent the dryer with nitrogen or another nonoxidizing inert gas. If desired, however, it is also possible simply just to lower the partial pressure of the oxygen during the drying in order to prevent oxidative yellowing processes. In general, though, adequate venting and removal of the water vapor also still lead to an acceptable product. A very short drying time is generally advantageous with regard to color and product quality.

A further important function of the drying of the gel is the reduction of the residual monomer content in the superabsorbent which is still taking place here. This is because, in the course of drying, any residues of the initiators still present decompose and lead to polymerization of residual monomers still present. Moreover, the amounts of water evaporating entrain the steam-volatile monomers still present, for example acrylic acid, and thus likewise reduce the residual monomer content in the superabsorbent.

Thereafter, the dried hydrogel is ground and classified, and the apparatus used for grinding may typically be single- or multistage roll mills, preferably two- or three-stage roll mills, pin mills, hammer mills or vibratory mills.

The resulting polymer is then postcrosslinked. Postcrosslinkers e) suitable for this purpose are compounds which comprise at least two groups which can form covalent bonds with the carboxylate groups of the polymers. Suitable compounds are, for example, alkoxysilyl compounds, polyaziridines, polyamines, polyamidoamines, di- or polyglycidyl compounds, as described in EP-A 083 022, EP-A 543 303 and EP-A 937 736, or -hydroxyalkylamides, as described in DE-A 102 04 938 and U.S. Pat. No. 6,239,230. Also suitable are compounds with mixed functionality, such as glycidol, 3-ethyl-3-oxetanemethanol (trimethylolpropaneoxetane), as described in EP-A1 199 327, or compounds which form a further functionality after the first reaction, such as ethylene oxide, propylene oxide, isobutylene oxide, aziridine, azetidine or oxetane.

In addition, DE-A 40 20 780 describes cyclic carbonates, DE-A 198 07 502 2-oxazolidone and its derivatives such as N-(2-hydroxyethyl)-2-oxazolidone, DE-A 198 07 992 Bis- and poly-2-oxazolidinones, DE-A 198 54 573 2-oxotetrahydro-1,3-oxazine and its derivatives, DE-A 198 54 574 N-acyl-2-oxazolidones, DE-A 102 04 937 cyclic ureas, DE-A 103 34 584 bicyclic amide acetals, EP-A 1 199 327 oxetanes and cyclic ureas, and WO 03/031482 morpholine-2,3-dione and its derivatives, as suitable postcrosslinkers e).

Preferred postcrosslinkers e) are oxazolidone and its derivatives, especially N-(2-hydroxy-ethyl)-2-oxazolidone.

The amount of postcrosslinker e) is preferably from 0.08 to 0.22% by weight, more preferably from 0.1 to 0.2% by weight, based in each case on the polymer.

The postcrosslinkers e) are typically used in the form of an aqueous solution; preference is given to additionally using a cosolvent. Industrially highly suitable cosolvents are C₁-C₆-alcohols such as methanol, ethanol, n-propanol, isopropanol, n-butanol, sec-butanol, tert-butanol or 2-methyl-1-propanol, C₂-C₅-diols such as ethylene glycol, 1,2-propylene glycol, 1,3-propanediol or 1,4-butanediol, or ketones such as acetone.

When diols are used as the cosolvent, it should be ensured that the diols should act as postcrosslinkers only to a minor degree, if at all. Owing to their distinctly lower reactivity, this can be achieved by selection of suitable reaction conditions such as time and temperature.

The postcrosslinking is typically carried out in such a way that a solution of the postcrosslinker e) is sprayed onto the hydrogel or the dry polymer particles. The spray application is followed by thermal drying, and the postcrosslinking reaction may take place either before or during drying.

The spray application of a solution of the crosslinker is preferably carried out in mixers with moving mixing tools, such as screw mixers, paddle mixers, disk mixers, plowshare mixers and shovel mixers. Particular preference is given to vertical mixers, very particular preference to plowshare mixers and shovel mixers. Suitable mixers are, for example, Lödige® mixers, Bepex® mixers, Nauta® mixers, Processall® mixers and Schugi® mixers.

The thermal drying is preferably carried out in contact dryers, more preferably shovel dryers, most preferably disk dryers. Suitable dryers are, for example, Bepex® dryers and Nara® dryers. Moreover, it is also possible to use fluidized bed dryers.

The drying can be effected in the mixer itself, by heating the jacket or blowing in warm air. Equally suitable is a downstream dryer, for example a tray dryer, a rotary tube oven or a heatable screw. It is also possible, for example, to utilize an azeotropic distillation as the drying process.

Preferred drying temperatures are in the range from 170 to 250° C., preferably from 180 to 220° C., and more preferably from 190 to 210° C. The preferred residence time at this temperature in the reaction mixer or dryer is at least 45 minutes, more preferably at least 60 minutes.

The polyvalent cations f) usable in the process according to the invention are, for example, divalent cations such as the cations of zinc, magnesium, calcium and strontium, trivalent cations such as the cations of aluminum, iron, chromium, rare earths and manganese, tetravalent cations such as the cations of titanium and zirconium. Possible counterions are chloride, bromide, sulfate, hydrogensulfate, carbonate, hydrogencarbonate, nitrate, phosphate, hydrogenphosphate, dihydrogen-phosphate and carboxylate, such as acetate and lactate. Aluminum sulfate is preferred.

Typically, the polyvalent cation f is used in the form of an aqueous solution. The concentration of the polyvalent cation f in the aqueous solution is, for example, from 0.1 to 12% by weight, preferably from 0.5 to 8% by weight, more preferably from 1.5 to 4% by weight.

The amount of polyvalent cation f is preferably from 0.06 to 0.25% by weight, more preferably from 0.07 to 0.2% by weight, most preferably from 0.08 to 0.15% by weight, based in each case on the polymer.

The process according to the invention makes it possible to obtain water-absorbing polymers having a Centrifuge Retention Capacity (CRC) of at least 16 g/g, preferably from 28 to 50 g/g, more preferably from 30 to 40 g/g, most preferably from 31 to 35 g/g, and a permeability (FS-FIP) of at least 16×10⁻⁶ cm³ s/g, preferably from 17 to 45×10⁻⁶ cm³ s/g, more preferably from 19 to 35×10⁻⁶ cm³ s/g, most preferably from 20 to 28×10⁻⁶ cm³ s/g.

The present invention further provides the polymers obtainable by the process according to the invention, and also hygiene articles, especially diapers, which comprise them.

### Methods:

The measurements should, unless stated otherwise, by carried out at an ambient temperature of 23±2° C. and a relative humidity of 50±10%. The swellable hydrogel-forming polymer is mixed thoroughly before the measurement.

### Centrifuge Retention Capacity (CRC)

The Centrifuge Retention Capacity of the water-absorbing polymers is determined by the EDANA (European Disposables and Nonwovens Association) recommended test method No. 441.2-02 “Centrifuge Retention Capacity”.

### Liquid Transport (FS-FIP Free Swell Fixed Insult Permeability)

In this method, the permeability of a swollen gel layer for a certain amount of liquid is determined as a function of time.

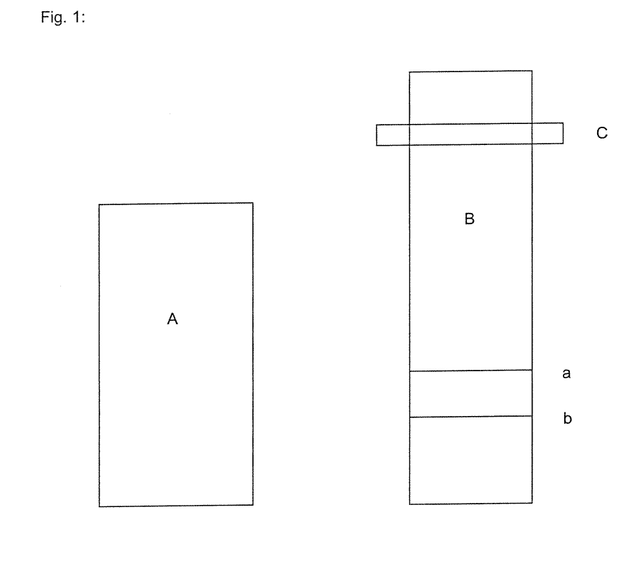

An illustration of the test cell can be found in FIG. 1. In this figure:

| | |
|---|---|
| A | outer cell |
| B | inner cell |
| C | weight |
| a | mark 1 |
| b | mark 2 |

The outer cell A is a Plexiglas cylinder which is closed at the bottom with a sieve and has an internal diameter of 2.55 cm.

The inner cell B is a Plexiglas cylinder which is closed at the bottom with a sieve and has an external diameter of 2.45 cm. In the upper region of the cell B is disposed an annular metal weight C. The applied weight of the cell B with the weight C is 29 g/cm².

At the start of the test, the inner cell B is inserted into the outer cell A and the height of the assembled test cell is measured and noted as h₀. Subsequently, the inner cell B is removed again. For the test, 0.160 g of superabsorbent are weighed into the outer cell A.

The prepared outer cell A is placed onto a sintered plate (porosity 0) which is in turn disposed in a Petri dish filled with 0.9% by weight sodium chloride solution, and the test material is swollen for one hour. Subsequently, the inner cell B with the weight C is inserted back into the outer cell A.

The gel layer is then washed twice with 25 ml each time of 0.9% by weight sodium chloride solution, the solution being introduced via the inner cell B and the height of the assembled test cell being measured as h₁.

For the actual measurement, 25 ml each time of the 0.9% by weight sodium chloride solution are added three times in succession to the gel bed, again via the inner cell B, and the times that the liquid level requires to flow through from mark 1 (6 cm above the sieve) down to mark 2 (4 cm above the sieve) of the inner cell B are each noted as t₁ to t₃. Finally, the height of the assembled test cell is measured once again as h₂.

The permeability of the swollen gel can then be derived by Darcy's Law.

The average gel height [cm] is calculated by

$${h}_{n} = \frac{( {h}_{2} - {h}_{0} ) + ( {h}_{1} - {h}_{o} )}{2}$$

The average flow-through time [s] is calculated by

$${t}_{n} = \frac{{t}_{1} + {t}_{2} + {t}_{3}}{3}$$

The average volumetric flow rate [cm³/s] is calculated by the following formula, the volume of 5.38 cm³ being calculated from the cell dimensions and the distance of 2 cm between the two marks (4 and 6 cm):

$$\frac{d V}{d t} = \frac{5.38 {cm}^{3}}{{t}_{n}}$$

H as the average height [cm] of the liquid above the bottom of the gel bed during the measurements is calculated by the following formula:

$$H = {h}_{n} * \frac{mark 1 + mark 2}{2}$$

The FS-FLP [10⁻⁶ cm³ s/g] is then determined by Darcy's Law:

$$FS - FIP = \frac{\frac{( d V )}{d t} * {h}_{n}}{A * P}$$

where A is the surface area of the gel bed (π²=5.107 cm²) and the average hydrostatic pressure P=ρgH (density ρ=1 g/cm³ and acceleration due to gravity g=981 cm/s²).

### EXAMPLES

### Example 1

5.166 g of a 37.3% by weight sodium acrylate solution were mixed with 574 g of acrylic acid and 720 g of water and inertized with nitrogen. This mixture was introduced into a nitrogen-inertized Werner & Pfleiderer LUK 8,0 K2 kneader (2 sigma shafts). This mixture corresponds to a degree of neutralization of acrylic acid of 72 mol %. Subsequently, 14 g of 15-tuply ethoxylated trimethylolpropane triacrylate (corresponds to 0.56% by weight based on acrylic acid), 10 g of 0.75% by weight ascorbic acid solution, 16.6 g of a 15% by weight sodium persulfate solution and 3.75 g of a 3% by weight hydrogen peroxide solution were added in succession. The kneader was stirred at maximum speed (98 rpm of the faster shaft, approx. 49 rpm on the slower shaft, ratio approx. 2:1). Immediately after the addition of hydrogen peroxide, the kneader jacket was heated to 80° C. After the maximum temperature had been attained, the kneader jacket was not heated any further and the mixture was allowed to react for a further 15 minutes. The gel was cooled to 65° C. and discharged. A gel with some gel lumps of approx. 1 to 2 cm in size was obtained.

The gel was dried in a forced-air drying cabinet with a loading of 700 g per sheet at 170° C. for 75 minutes. After grinding three times in a roll mill (Gebr. Baumeister LRC 125/70, gap widths 1000 μm, 600 μm and 400 μm), the polymer was sieved off to a sieve cut between 850 and 100 μm.

The polymer prepared had a Centrifuge Retention Capacity (CRC) of 35.8 g/g.

### Example 2

### Comparative

A polymer prepared as in Example 1 with a degree of neutralization of acrylic acid of 72 mol %, 0.56% by weight of a 15-tuply ethoxylated trimethylolpropane triacrylate and a CRC of 35.5 g/g was sprayed in a laboratory plowshare mixer from Lödige by means of a two-material nozzle with an aqueous surface postcrosslinker solution (0.1% by weight of ethylene glycol diglycidyl ether, 2.3% by weight of water, 1.0% by weight of 1,2-propanediol). Thereafter, 1.36% by weight of a 22% by weight aluminum sulfate solution was sprayed on and the product was heat-treated at 175° C. for one hour. Cooling was followed by sieving off from 106 to 850 μm.

### Example 3

### Comparative

A polymer prepared as in Example 1 with a degree of neutralization of acrylic acid of 72 mol %, 0.84% by weight of a 15-tuply ethoxylated trimethylolpropane triacrylate and a CRC of 32 g/g was sprayed in a laboratory plowshare mixer from Lödige by means of a two-material nozzle with an aqueous surface postcrosslinker solution (0.12% by weight of ethylene glycol diglycidyl ether, 1.8% by weight of water, 0.6% by weight of 1,2-propanediol). Thereafter, 2.45% by weight of a 22% by weight aluminum sulfate solution was sprayed on and the product was heat-treated at 180° C. for one hour. Cooling was followed by sieving off from 106 to 850 μm.

### Example 4

A polymer prepared as in Example 1 with a degree of neutralization of acrylic acid of 72 mol %, 0.44% by weight of 3-tuply ethoxylated glycerol triacrylate and a CRC of 36 g/g was sprayed in a laboratory plowshare mixer from Lödige by means of a two-material nozzle with an aqueous surface postcrosslinker solution (0.12% by weight of ethylene glycol diglycidyl ether, 1.8% by weight of water, 0.6% by weight of 1,2-propanediol). Thereafter, 2.45% by weight of a 22% by weight aluminum sulfate solution was sprayed on and the product was heat-treated at 175° C. for one hour. Cooling was followed by sieving off from 106 to 850 μm.

### Example 5

A polymer prepared as in Example 1 with a degree of neutralization of acrylic acid of 75 mol %, 0.21% by weight of polyethylene glycol diacrylate (approx. 9 ethylene oxide units) a CRC of 39.9 g/g was sprayed in a laboratory plowshare mixer from Lödige by means of a two-material nozzle with an aqueous surface postcrosslinker solution (0.08% by weight of ethylene glycol diglycidyl ether, 0.75% by weight of water, 0.75% by weight of 1,2-propanediol). Thereafter, 2.45% by weight of a 22% by weight aluminum sulfate solution was sprayed on and the product was heat-treated at 180° C. for one hour. Cooling was followed by sieving off from 106 to 850 μm.

### Example 6

A polymer prepared as in Example 1 with a degree of neutralization of acrylic acid of 75 mol %, 0.18% by weight of 3-tuply ethoxylated glycerol triacrylate and a CRC of 40.2 g/g was sprayed in a laboratory plowshare mixer from Lödige by means of a two-material nozzle with an aqueous surface postcrosslinker solution (0.1% by weight of N-(2-hydroxyethyl)-2-oxazolidinone, 0.75% by weight of water, 0.75% by weight of isopropanol). Thereafter, 2.45% by weight of a 22% by weight aluminum sulfate solution was sprayed on and the product was heat-treated at 190° C. for one hour. Cooling was followed by sieving off from 106 to 850 μm.

### Example 7

A polymer prepared as in Example 1 with a degree of neutralization of acrylic acid of 77 mol %, 0.18% by weight of 3-tuply ethoxylated glycerol triacrylate and a CRC of 41 g/g was sprayed in a laboratory plowshare mixer from Lödige by means of a two-material nozzle with an aqueous surface postcrosslinker solution (0.08% by weight of ethylene glycol diglycidyl ether, 0.75% by weight of water, 0.75% by weight of 1,2-propanediol). Thereafter, 2.45% by weight of a 22% by weight aluminum sulfate solution was sprayed on and the product was heat-treated at 170° C. for one hour. After cooling to 40-50° C., another 2.45% by weight of a 22% by weight aluminum sulfate solution was sprayed on, the mixture was mixed for another 10 minutes and the product was finally sieved off at from 106 to 850 μm.

TABLE 1

| | FS-FIP | CRC |
|---|---|---|
| | [10⁻⁶ cm³ s/g] | [g/g] |
| Example 1 (Comp.) | 0.83 | 35.8 |
| Example 2 (Comp.) | 11.68 | 28.0 |
| Example 3 (Comp.) | 27.34 | 23.4 |
| Example 4 | 27.34 | 28.9 |
| Example 5 | 17.93 | 33.7 |
| Example 6 | 18.65 | 32.4 |
| Example 7 | 24.16 | 33.1 |

1. A process for preparing water-absorbing polymers by polymerizing a monomer solution comprising
(a) at least one ethylenically unsaturated, acid-bearing monomer, optionally at least partly neutralized,
(b) from 0.01 to 0.5% by weight of at least one crosslinker based on the monomer a),
(c) optionally one or more ethylenically and/or allylically unsaturated monomers copolymerizable with the at least one monomer a) and
(d) optionally one or more water-soluble polymers, by polymerizing the monomer solution and aftertreating a resulting polymer with
(e) from 0.05 to 0.25% by weight of at least one postcrosslinker, based on the polymer, where the crosslinker is different from a polyol, and
(f) from 0.05 to 0.5% by weight of at least one polyvalent cation based on the polymer.

2. The process according to claim 1, wherein the postcrosslinker and the polyvalent cation are added in a common process step.

3. The process according to claim 1, wherein the postcrosslinker is added before the polyvalent cation.

4. The process according to claim 1, wherein the polymer is heated during or after addition of the postcrosslinker.

5. The process according to claim 4, wherein the polymer is heated during or after addition of the postcrosslinker and before addition of the polyvalent cation.

6. The process according to claim 1, wherein the polymer is heated to at least 170° C. after addition of the postcrosslinker.

7. The process according claim 1, wherein the polymer is heated for at least 45 minutes after addition of the postcrosslinker.

8. The process according to claim 1, wherein the ethylenically unsaturated, acid-bearing monomer has been neutralized to an extent of at least 60 mol %.

9. A water-absorbing polymer comprising
i) at least one polymerized ethylenically unsaturated, acid-bearing monomer, optionally at least partly neutralized,
ii) from 0.01 to 0.5% by weight of at least one polymerized crosslinker based on the at least one monomer i),
iii) optionally one or more polymerized ethylenically and/or allylically unsaturated monomers copolymerizable with the at least one monomer i),
iv) one or more water-soluble polymer to which the at least one monomer i) has at least partly been grafted,
v) from 0.05 to 0.25% by weight of at least one polymerized postcrosslinker, based on the polymer, wherein the crosslinker is different from a polyol, and
vi) from 0.05 to 0.5% by weight of at least one polyvalent cation based on the polymer.

10. The polymer according to claim 9, wherein the polymerized ethylenically unsaturated, acid-bearing monomer has been neutralized to an extent of at least 60 mol %.

11. A polymer having a Centrifuge Retention Capacity (CRC) of at least 27 g/g and a permeability (FS-FIP) of at least 16×10⁻⁶ cm³ s/g.

12. A hygiene article comprising a water-absorbing polymer according to claim 9.
